(19) United States
(12) Patent Application Publication
(10) Pub. No.: US 2002/0182299 A1
(43) Pub. Date: Dec. 5, 2002

(54) Process for manufacturing fibre-enriched fruit-based compositions and compositions thus obtained

(76) Inventor: Michel Serpelloni, Beuvry-Les-Bethune (FR)

Correspondence Address: HENDERSON & STURM LLP, 1213 MIDLAND BUILDING, 206 SIXTH AVENUE, DES MOINES, IA, 50309-4076, US

(21) Appl. No.: 10/113,100

(22) Filed: Mar. 29, 2002

(30) Foreign Application Priority Data
Mar. 30, 2001 (FR) 01 04420

(51) Int. Cl. A23L 1/236

(52) U.S. Cl. 426/548

(57) ABSTRACT

The subject of the invention is a process for manufacturing fiber-enriched fruit-based compositions, comprising the step consisting in incorporating 1 to 30%, preferably 2 to 20%, and still more preferably 2.5 to 15% by weight, relative to the finished product, of branched maltodextrins having between 15 and 35% of 1→6 glucoside linkages, a reducing sugar content of less than 20%, a polymolecularity index of less than 5 and a number-average molecular mass Mn at most equal to 4500 g/mol. The subject of the invention is also a fiber-enriched fruit-based composition, comprising 1 to 30%, preferably 2 to 20% and still more preferably 2.5 to 15% by weight, relative to the finished product, of the said branched maltodextrins.

### FIELD OF THE INVENTION

The subject of the present invention is a process for manufacturing fibre-enriched fruit-based compositions using a particular saccharide. Its subject is also the compositions obtained according to this process, containing such a particular saccharide.

The expression fruit-based compositions, for the purposes of the present invention, is understood to mean in particular preparations such as jams, jellies, sugar-fruits, fruit jellies, marmalades, compotes, fruit garnish, fillings, coverings, etc.

### BACKGROUND OF THE INVENTION

The jams, jellies and fruit jellies are prepared by adding a large quantity of sugars, such as sucrose and glucose syrup in most cases, to natural fruit juice or to fruits. Pectin and citric acid are generally added to the jams and jellies, as well as modified starches to some jams for filling or covering, and to some fruit preparations, in order to improve cooking resistance. A product which is firm to a greater or lesser degree is thus obtained whose consistency varies according to the nature of the fruit, from that of a jelly as such to that of a paste, and whose texture is corrected by addition of pectin. Jams and jellies comprising fruits, sugars and pectin generally have a dry matter content of 30 to 70%. Jams for filling comprise, in addition, starches having, for their part, a dry matter content of 80 to 90%, whereas fruit preparations have a dry matter content of 30 to 60%.

Fruit jellies comprising fruits, sugars and pectin have a dry matter content of 70 to 85%.

Sugar-fruits are intermediate preparations intended to be added to yoghurts, fromage blanc-type cheeses, to ice-creams and to pastries. These preparations consist of a mixture of fruits and sugar, which is heat-treated and which contains technical ingredients such as flavourings, colourings and texturing agents. The texturing agents have two functions. They should give a texture to the sugar-fruit which is pumpable, and they should avoid exudation of juice into the final product.

These texturing agents are in particular pectins, whose gelling power is well known and which are widely used in the preparation of jams. Also used are carrageenans, gums, alginates, xanthan and modified starches or maltodextrins, the use of one or the other depending on the final product. In the case where sugar-fruits or jams are used in pastry manufacture, there is the problem of additional cooking during the baking of the cake or of the biscuit. Texturing agents then have to be chosen which are heat-resistant. Knowing, moreover, that these compositions, which are often visible in the final product, have to preserve a visual appearance of higher quality from the point of view of the colour, the use of maltodextrins is limited by this condition because they generate a brown colour during cooking. The texturing agents should also be stable under the generally acidic pH conditions of jams, jellies and fillings, that is to say that these texturing agents should not undergo hydrolysis over time, which would result in texture modifications and colour and taste modifications which are undesirable.

In addition to these technological considerations, manufacturers are increasingly concerned with nutrition and the potential benefits of foods. Indeed, the frequency of cancers and coronary diseases, the mistrust of consumers following the recent crisis in the agri-foodstuffs industry, and the popularization of recent nutritional knowledge reinforce this desire for healthy products, which make it possible to live better and longer. Dietary fibres have thus come to the forefront of functional ingredients. Indeed, they play a protective role against cancer, cardiovascular diseases, diabetes or obesity. It therefore seems advantageous to enrich foods with fibres.

Having acknowledged this state of the art, the Applicant setS himself the objective of developing fibre-enriched fruit-based compositions using a technical ingredient which satisfies all the abovementioned requirements.

It is after numerous trials and studies that the Applicant has had the merit of finding that the objective defined above could be achieved provided a branched maltodextrin having quite particular analytical parameters is used.

### DESCRIPTION OF THE INVENTION

The subject of the present invention is therefore a process for manufacturing fibre-enriched fruit-based compositions, characterized in that it comprises the step consisting in incorporating 1 to 30%, preferably 2 to 20%, and still more preferably 2.5 to 15% by weight, relative to the finished product, of branched maltodextrins having between 15 and 35% of 1→6 glucoside linkages, a reducing sugar content of less than 20%, a polymolecularity index (ratio of weight-average molecular mass over number-average molecular mass) of less than 5 and a number-average molecular mass Mn at most equal to 4500 g/mol.

The expression branched maltodextrins is understood to mean, for the purposes of the present invention, the maltodextrins described in patent application EP 1 006 128 of which the assignee is proprietor, and its U.S. counterpart U.S. 09/455,009, the content of which is incorporated herein by reference. These branched maltodextrins have an indigestibility character which has the consequence of reducing their calorific value, by preventing their assimilation in the small intestine. They therefore represent a source of indigestible fibres which are beneficial to the metabolism and the intestinal balance. As an indication, their insoluble fibre level is generally greater than 50% on a dry matter basis. Their low content of molecules having a low degree of polymerization (“DP”) also contributes to their low calorific value. Their high content of 1→6 glucoside linkages has the consequence of reducing their cariogenic power by reducing their assimilation by the microorganisms of the buccal cavity. This high level of 1→6 linkages also confers quite particular prebiotic properties on them: it has indeed appeared that the bacteria of the caecum and of the colon of humans and animals, such as the butyrogenic, lactic or propionic bacteria, metabolize highly branched compounds. Moreover, these branched maltodextrins promote the development of bifidogenic bacteria to the detriment of the undesirable bacteria. This results in properties which are quite beneficial to the health of the consumer.

Products having similar functionalities, such as in particular the fructooligosaccharides marketed under the name ACTILIGHT or RAFTILOSE, which also have beneficial effects on health in terms of bifidogenic properties and supply of fibres, have been proposed in the fibre-enriched foods. These products have, nevertheless, the disadvantage of being very unstable under acidic pH conditions, as will be exemplified. This instability results in gradual hydrolysis during storage, which generates an undesirable release of glucose and fructose. This instability is dissuasive for use in fruit-based compositions practically all of which have an acidic pH.

The applicant then found that by using the said branched maltodextrins in a process for manufacturing fruit-based compositions, fibre-enriched fruit-based compositions could be advantageously obtained by a process which is easier and quicker than conventional processes. Indeed, the incorporation of the said branched maltodextrins into the mixture of fruits and sugar before cooking advantageously reduces the boiling point of the mixture, which implies a lower temperature and a shorter cooking time and, consequently, better preservation of the organoleptic qualities of the finished product (colour and taste, texture of the fruits). Moreover, the said branched maltodextrins are stable under acidic pH conditions, and are stable to cooking as will be exemplified.

All the compositions of the branched maltodextrins described in patent application EP 1 006 128 and its U.S. counterpart U.S. 09/455,009 are appropriate for the manufacture of fruit-based compositions according to the invention.

According to a preferred variant, the said branched maltodextrins have a reducing sugar content of between 2 and 5% and an Mn of between 2000 and 3000 g/mol.

According to another advantageous variant, all or part of the branched maltodextrins are hydrogenated.

The subject of the invention is also a fibre-enriched fruit-based composition, characterized in that it comprises 1 to 30%, preferably 2 to 20%, and still more preferably 2.5 to 15% by dry weight, relative to the finished product of branched maltodextrins having between 15 and 35% of 1→6 glucoside linkages, a reducing sugar content of less than 20%, a polymolecularity index of less than 5 and a number-average molecular mass Mn at most equal to 4500 g/mol.

Advantageously, the said branched maltodextrins have a reducing sugar content of between 2 and 5% and an Mn of between 2000 and 3000 g/mol.

According to another advantageous variant, all or part of the said branched maltodextrins are hydrogenated.

Preferably, a fruit-based composition according to the invention comprises 1 to 60% of fruits, 20 to 70% of sugars and 1 to 30% of the said branched maltodextrins, these percentages being expressed by dry weight relative to the finished product. As an indication, the percentages of fruits expressed by weight in the preparation before cooking are generally between 10 and 80%, according to the type of preparation considered. Compotes and jellies most often use more fruits than the compositions for filling or covering. It is particularly advantageous to use such fibre-enriched fruit-based compositions for the filling or covering of pastries or biscuits when it is desired to attribute bifidogenic virtues to these products and when the processes for manufacturing them do not make it possible to reach the bifidogenic dose desired and necessary to claim an influence on the intestinal flora of the consumer. Likewise, for the manufacture of double-layer yoghurts containing fruit preparations, the desired bifidogenic dose may be obtained both through the yoghurt itself and through the fruit preparation which is added to it. This advantageously limits the technological constraints on the yoghurt formulator.

The invention will be understood more clearly on reading the examples which follow and the figure relating thereto, which are intended to be illustrative and nonlimiting.

### EXAMPLES

### Example 1

### Preparation of a Jam Filling

To prepare a jam filling, a process according to the invention is used which comprises the use of branched maltodextrins in comparison with a conventional process.

The branched maltodextrins used have between 15 and 35% of 1→6 glucoside linkages, a reducing sugar content of between 2 and 5%, a polymolecularity index of less than 5 and a number-average molecular mass Mn of between 2000 and 3000 g/mol:

| | |
|---|---|
| Reducing sugars | 2.3 |
| Mn (g/mol) | 2480 |
| Mw (g/mol) | 5160 |
| 1, 2 linkage (%) | 10 |
| 1, 3 linkage (%) | 12 |
| 1, 4 linkage (%) | 49 |
| 1, 6 linkage (%) | 29 |

Conventional process: The branched maltodextrins are replaced either with a glucose syrup (FLOLYS® E7081 marketed by the assignee), or with a standard maltodextrin (GLUCIDEX®29 marketed by the assignee).

The ingredients are mixed (see table below), and then the mixture is cooked on a naked flame, with boiling, for a period necessary to obtain a brix of 90. The cooking parameters are described in the table below.

| | PROCESS | | |
|---|---|---|---|
| | ACCORDING | CONVEN- | |
| INGREDIENTS | TO THE | TIONAL | CONVENTIONAL |
| (by weight) | INVENTION | PROCESS 1 | PROCESS 2 |
| Branched | 200 | — | — |
| maltodextrins | | | |
| FLOLYS ® E7081 | — | 246.9 | — |
| GLUCIDEX ®29 | — | — | 200 |
| WATER | 50 | 3.1 | 50 |
| APRICOT PUREE | 350 | 350 | 350 |
| SUCROSE | 400 | 400 | 400 |
| Initial | 1050 mPa.s | 1900 mPa.s | 2000 mPa.s |
| viscosity | | | |
| Time necessary | 6 min 20 sec | 6 min 10 sec | 6 min 20 sec |
| up to boiling | | | |
| Variation of | | | |
| the brix | | | |
| After 10 min | 64 | 65 | 65 |
| After 12 min | 69 | 67 | 69 |
| After 14 min | 71 | 69 | 71 |
| After 18 min | 75 | 72 | 74 |
| After 22 min | 81 | 77 | 80.5 |
| After 26 min | 90 | 85 | 90 |
| After 28 min | | 88 | |
| After 30 min | | 90 | |
| Brown colour | Faint | Strong | Medium |

It is observed that the time necessary to obtain a brix of 90 is less when a standard maltodextrin or a branched maltodextrin is used. This is particularly advantageous as regards the preservation of the nutritional and organoleptic qualities of the fruit, since the cooking is shorter.

However, the organoleptic qualities of the product obtained according to the process in accordance with the invention are superior to those obtained with a conventional maltodextrin, in the sense that an undesirable brown colour is generated with the conventional processes. This colour is also observed when a glucose syrup is used.

The fruit-based composition according to the invention is advantageously enriched with fibres and stable, by virtue of the use of branched maltodextrins which are stable in acidic medium and stable during cooking.

### Example 2

### Study of Stability in Acidic Medium

In order to assess the stability of the branched maltodextrins in acidic media, solutions are prepared at different pH values, containing either fructooligosaccharides (ACTILIGHT), or branched maltodextrins in accordance with the invention.

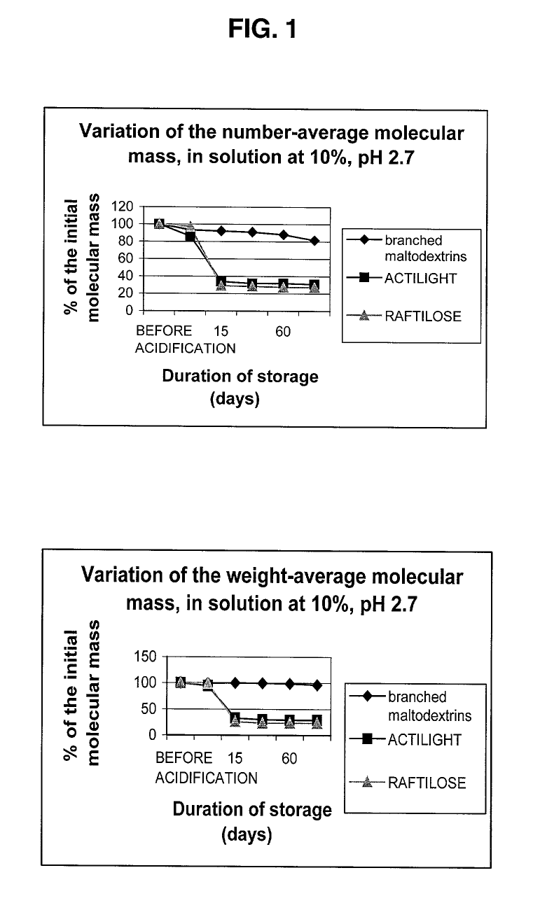

The variation of the molecular masses of these oligosaccharides in solution are measured during storage by steric exclusion followed by differential refractometric detection. The results are illustrated by FIG. 1. In the case of the branched maltodextrins, a very slight effect of the acidification of the solutions is observed. A slight hydrolysis therefore exists at very acidic pH values (less than 3) which results in a variation of the molecular weight towards lower values. After two weeks of storage, the differences are not greater than those observed immediately after acidification. After 1 month of storage, only the values obtained for the very low pH values (less than 2.7) decreased compared with the two weeks ageing. The number-average molecular weight passes from 2800 Daltons to 2400 Daltons for solutions at pH 2.

In the case of fructooligosaccharides, after two weeks of storage at pH 2, the molecular weight is reduced to 30% of its initial value. After 1 month, the solutions at pH 2 and 2.7 contain very highly degraded ACTILIGHT.

Conclusion: the branched maltodextrins are well suited to the manufacture of fruit-based compositions such as jams, jellies, fillings and fruit preparations generally having a pH of less than 3.

### Example 3

### Fruit Preparation for Yoghurts

Formula:

| | % by weight | | |
|---|---|---|---|
| | | | Fruit |
| | | Fruit | Preparation with |
| | | preparation | no added sugar |
| | Control fruit | according to | according |
| Ingredient | preparation | the invention | to the invention |
| Sucrose | 25.2 | 20.7 | 0 |
| Glucose syrup | 16.8 | 13.8 | 0 |
| MELIOSE ®401981 | | | |
| Fruit purée** | 21 | 21 | 21 |
| Modified starch | 1.6 | 1.6 | 1.6 |
| CLEARAM ®CR0820 | | | |
| Branched | 0 | 7.5 | 42 |
| maltodextrins | | | |
| (see ex. 1) | | | |
| Water | 34.65 | 34.65 | 34.65 |
| Pectin | 0.6 | 0.6 | 0.6 |
| Unipectine OF 627 | | | |
| (DEGUSSA) | | | |
| Aspartame | 0 | 0 | 0.9 |
| Acesulfame K | 0 | 0 | 0.9 |
| Citric acid*** | 0.1 | 0.1 | 0.1 |
| Potassium sorbate | 0.05 | 0.05 | 0.05 |
| TOTAL | 100 | 100 | 100 |

**Concentrated deep-frozen fruit purée at 50° brix
***% citric acid to be added in order to obtain a pH of 3.8 (pH of a fruit preparation intended to be mixed with a yoghurt).

Procedure: The fruits are mixed with half of the sucrose or of the intense sweeteners, the glucose syrup, the modified starch and the citric acid. The solution of pectin-branched maltodextrins and the rest of the sucrose is heated in water at 85° C. for 5 minutes and it is added to the previous mixture. The mixture is cooked at 95° C. for 5 minutes and potassium sorbate is added.

Comments: The branched maltodextrins exhibit excellent stability in acidic medium while withstanding the heat treatments, two essential criteria for the production of sugar-fruits. It is not therefore necessary to overdose the starting formula in order to preserve the desired dose of fibres at the end of the process and at the end of the optimum use-by date.

According to the invention, the said branched maltodextrins give the preparation higher viscosity than the control recipe without soluble fibres, the preparations have more body and develop a much more pleasant sensation.

Taste panel: a panel of 20 people are made to taste the fruit preparations according to the invention in comparison with the control recipe. Two criteria are evaluated: viscosity in the mouth and jelly appearance. The score 0 is given to the control for each criterion, the results are given in the table below (mean scores):

| | | | RECIPE 2 (with |
|---|---|---|---|
| | CONTROL | RECIPE 1 | no sugar) |
| VISCOSITY IN THE | 0 | +0.4 | +0.8 |
| MOUTH | | | |
| JELLY APPEARANCE | 0 | +0.5 | +1.8 |

The fruit preparations according to the invention have a more jelly-like appearance than the control: the visual appearance is improved.

Moreover, it was observed that the preparations according to the invention had a high yield point, which is particularly advantageous for the preparation of bilayer yoghurts in which the risk of mixing the fruited sublayer with the white mass is substantially reduced.

All the combined characteristics of the compositions according to the invention mean that they are particularly advantageous for fruit preparations, both from the nutritional point of view (supply of fibres, low calorific value) and from the rheological and organoleptic point of view.

### Example 4

### Study of Stability to Cooking

Fruit preparations are prepared according to the same recipe as in the previous example, and comprise respectively: 19% of branched maltodextrins, 19% of hydrogenated branched maltodextrins, 42% of branched maltodextrins. The first two preparations also comprise 23% of sucrose. A control without branched maltodextrins is prepared with 44.6% of sucrose. The preparations are subjected to cooking at 95° C. for 5 minutes and at pH 3.8.

The level of sucrose and of branched maltodextrins in the preparations is measured after cooking. The results are given by the following table:

| | | 19% | 19% | 42% |
|---|---|---|---|---|
| | | branched | hydrogenated | branched |
| LEVEL AFTER | | malto- | branched | malto- |
| COOKING | CONTROL | dextrins | maltodextrins | dextrins |
| Sucrose | 44.6% | 24% | 24.2% | — |
| Branched | — | 20.3 | — | 45.9 |
| maltodextrins | | | | |
| Hydrogenated | — | — | 18.9 | — |
| branched | | | | |
| maltodextrins | | | | |

These results illustrate the good stability of the branched maltodextrins after a heat treatment at acidic pH, the latter not being hydrolysed.

1. A process for manufacturing a fibre-enriched fruit-based composition, comprising the step consisting in incorporating 1 to 30% by weight, relative to the finished product, of branched maltodextrins having between 15 and 35% of 1→6 glucoside linkages, a reducing sugar content of less than 20%, a polymolecularity index of less than 5 and a number-average molecular mass Mn at most equal to 4500 g/mol.

2. The process of claim 1, wherein 2 to 20% by weight of said branched maltodextrins are incorporated.

3. The process of claim 3, wherein 2.5 to 15% by weight of said branched maltodextrins are incorporated.

4. The process of claim 1, wherein said branched maltodextrins have a reducing sugar content of between 2 and 5% and an Mn of between 2000 and 3000 g/mol.

5. The process of claim 1, wherein all or part of said branched maltodextrins are hydrogenated.

6. A fibre-enriched fruit-based composition, comprising 1 to 30% by dry weight, relative to the finished product, of branched maltodextrins having between 15 and 35% of 1→6 glucoside linkages, a reducing sugar content of less than 20%, a polymolecularity index of less than 5 and a number-average molecular mass Mn at most equal to 4500 g/mol.

7. The fruit-based composition of claim 6, comprising 2 to 20% by dry weight of said branched maltodextrins.

8. The fruit-based composition of claim 7, comprising 2.5 to 15% by dry weight of said branched maltodextrins.

9. The fruit-based composition of claim 6, wherein said branched maltodextrins have a reducing sugar content of between 2 and 5% and an Mn of between 2000 and 3000 g/mol.

10. The fruit-based composition of claim 6, wherein all or part of said branched maltodextrins are hydrogenated.

11. The fruit-based composition of claim 6, comprising 1 to 60% by dry weight of fruits, 20 to 70% by dry weight of sugars, and 1 to 30% by dry weight of the said branched maltodextrins, these percentages being expressed relative to the finished product.
